(19) United States
(12) Patent Application Publication
(10) Pub. No.: US 2005/0103575 A1
(43) Pub. Date: May 19, 2005

(54) Hydraulic elevator repair safety platform

(76) Inventor: George W. Hager II, Baton Rouge, LA (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/714,248

(22) Filed: Nov. 13, 2003

(51) Int. Cl. B66B 9/04

(52) U.S. Cl. 187/272

(57) ABSTRACT

A safety platform for repair of a hydraulic elevator adapted to be attached to an underside of the elevator car to militate against vertical movement of the elevator car while repairs are being conducted on the hydraulic elevator.

### FIELD OF THE INVENTION

The present invention relates to an elevator safety platform and more particularly to a safety platform for hydraulic elevator repair.

### BACKGROUND OF THE INVENTION

A hydraulic type elevator is operated by a hydraulic system including a jack assembly, a piston assembly, and a network of oil lines. Repairing one of the above components of the hydraulic elevator often requires an elevator mechanic or building maintenance personnel to enter a hoistway under an elevator car while conducting the repairs. Persons that enter the hoistway may suffer serious or fatal accidents if the elevator car moves unexpectedly. Such accidents commonly occur in a pit where the person is crushed by the unexpected movement of the elevator car.

A safety system commonly employed to prevent such accidents is the use of a safety switch located in the elevator car. The mechanic typically will enter the elevator car while parked at a specified floor and manually transfer the switch from a normal mode to an inspection mode. Such a system is ineffective in a hydraulic elevator if there is a rupture in one of the components causing a loss of hydraulic fluid.

It would be desirable to produce a hydraulic elevator repair safety platform for use in elevator hoistways of varying dimensions which militates against vertical movement of an elevator car during repair of the elevator.

### SUMMARY OF THE INVENTION

Consistent and consonant with the present invention, a hydraulic elevator repair safety platform for use in elevator hoistways of varying dimensions which militates against vertical movement of an elevator car during repair of the elevator, has surprisingly been discovered.

The hydraulic elevator repair safety platform comprises an elongate central beam having a first end and a second end, the beam adapted to be connected to an elevator car; a guide clamp assembly connected to the beam and adapted to be received by an elevator guide rail system, the guide clamp assembly having an actuation arm actuated by a downward movement of the elevator car, whereby the actuation of the actuation arm causes the guide clamp assembly to grip the guide rail system which facilitates immobilization of the elevator car.

### BRIEF DESCRIPTION OF THE DRAWINGS

The above, as well as other objects, features, and advantages of the present invention will be understood from the detailed description of the preferred embodiments of the present invention with reference to the accompanying drawings, in which:

FIG. 1 is a front elevation view of a hydraulic elevator repair safety platform incorporating the features of the invention and schematically showing a portion of an elevator car;

FIG. 2 is a side elevation view showing an end portion of the hydraulic elevator repair safety platform illustrated in FIG. 1;

FIG. 3 is a top plan view of the end portion of the hydraulic elevator repair safety platform illustrated in FIG. 2;

FIG. 4 is a front elevation view showing a central beam of the hydraulic elevator repair safety platform illustrated in FIG. 1; and

FIG. 5 is a side elevation view of the central beam portion illustrated in FIG. 4.

### DETAILED DESCRIPTION OF THE PREFERRED EMBODIMENT

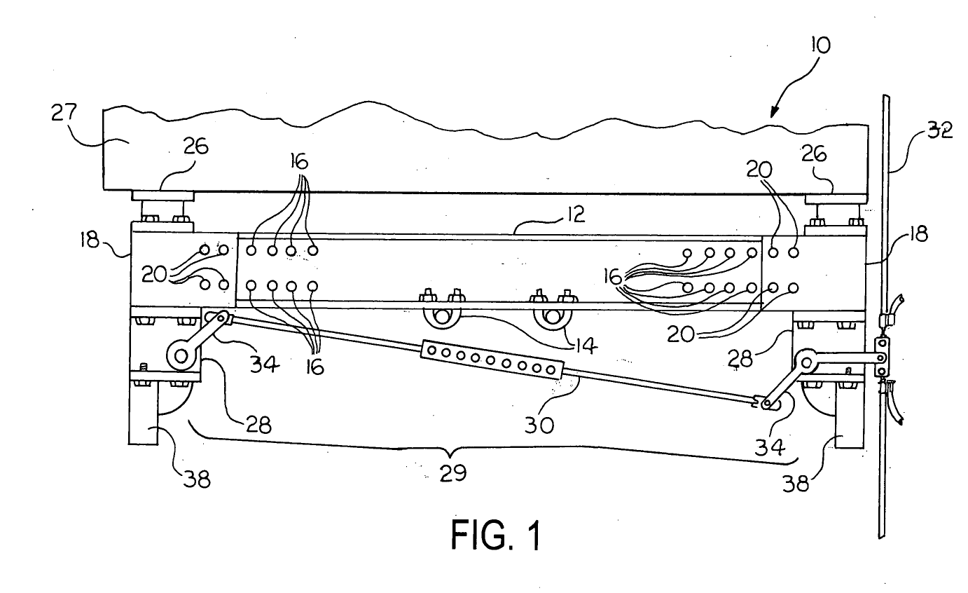

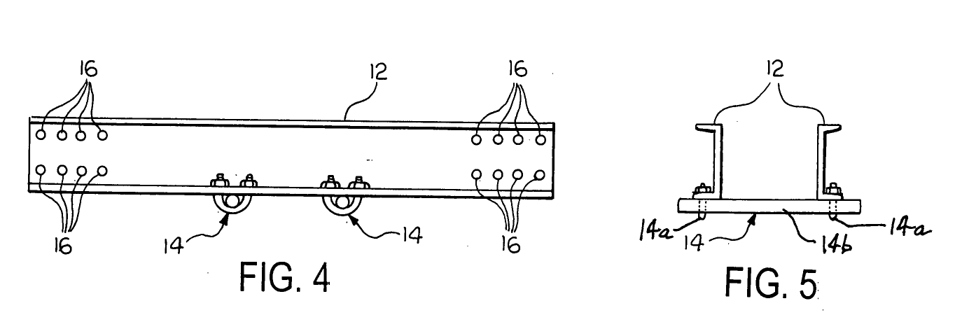

Referring now to the drawings, and particularly FIG. 1, there is shown generally at 10 a hydraulic elevator repair safety platform incorporating the features of the invention. The safety platform 10 includes an elongate central beam 12. In the embodiment shown, a pair of spaced apart steel channel sections comprise the central beam 12, as clearly shown in FIG. 5. It is understood that other beam structures such as a single beam, for example, could be used without departing from the scope and spirit of the invention. A plurality of rigging members 14 depend from the channel sections of the central beam 12. As shown in FIGS. 1, 4, and 5, the rigging members 14 include pairs of U-bolts 14a with each U-bolt of a pair attached to an associated one of the channel sections. A length of piping or rod 14b extends between the U-bolts of each pair and is held therein to maintain the spaced relationship of the channel sections. A plurality of holes 16 are disposed at each end of each of the channel sections of the central beam 12.

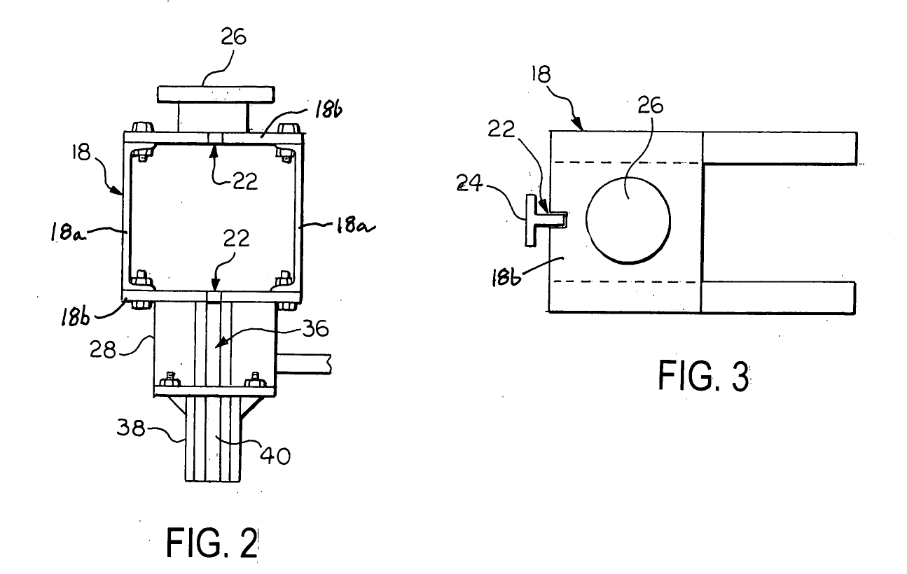

Each end of the central beam 12 has an end portion 18 connected thereto. A plurality of holes 20 are formed in the end portions 18, and can be selectively aligned with the holes 16 of the central beam 12 to receive fasteners (not shown) and to facilitate an adjustment of the overall length of the safety platform 10. In the embodiment shown, a pair of spaced apart steel channel sections 18a comprise the sides of the end portions 18, as clearly shown in FIG. 2. The channel sections 18a are connected by top and bottom plates 18b attached by suitable fasteners. It is understood that other end portion structures could be used without departing from the scope and spirit of the invention. A slot 22 is formed in one end of each of the plates 18b of the end portions 18, as illustrated in FIGS. 2 and 3. The slots 22 of the end portions 18 receive an elevator guide rail 24 therein as shown in FIG. 3. The guide rail 24 is attached to a wall of an elevator hoistway (not shown). In the embodiment shown, the guide rail 24 is a T-rail with the stem received in the slot 22. It is understood that other guide rails could be used without departing from the scope and spirit of the invention.

An upwardly extending adapter guide shoe plate 26 is disposed on the top one of the plates 18b of each of the end portions 18. The guide shoe plates 26 are adapted to be connected to an elevator car 27. The connection may be achieved by removing roller/slide guides (not shown) from the underside of the elevator car 27 and attaching the guide shoe plates 26 to the elevator car 27 at the point where the roller/slide guides were removed.

As shown in FIG. 1, a guide clamp assembly 29 is connected to the safety platform 10 on the end portions 18. The guide clamp assembly 29 includes a pair of guide clamps 28, an adjustable guide clamp linkage 30, and a safety cable 32. Such a guide clamp assembly 29 can be purchased as an assembly commercially available as a Type “A” Instantaneous Model 540 Safety from Hollister Whitney, for example. The safety cable 32 is typically connected to a ceiling or a wall of the elevator hoistway. The safety cable 32 is also connected to one of the actuating arms 34 and through the linkage 30 to the other one of the arms 34. Each of the actuating arms 34 is connected to a clamping system (not shown) within the associated guide clamp 28 which cooperates to act as a brake. The linkage 30 facilitates simultaneous actuation of the actuating arms 34. A slot 36 formed in the guide clamp 28, as illustrated in FIG. 2, receives the guide rail 24 therein.

A pair of guide shoes 38 are connected to each of the guide clamps 28. A gap or space 40 is formed between the guide shoes 38 to receive the guide rail 24 therein, as shown in FIG. 2. Such a guide shoe 38 can be purchased such as is commercially available as Model No. 371 Guide Shoe from Hollister Whitney, for example.

When repair or maintenance of a hydraulic elevator is necessary, the elevator car 27 can be positioned as desired. The safety platform 10 is then attached to the underside of the elevator car 27 using the guide shoe plates 26. Adjustment of the overall length of the safety platform 10 is accomplished by aligning the apertures 16 of the central beam 12 with the holes 20 of the end portions 18 and bolting the central beam 12 to the end portions 18 to achieve the desired length.

The safety cable 32 is then connected to the wall or the ceiling of the elevator hoistway. The elevator car 27 is caused to move downwardly, thereby tensioning the safety cable 32 and causing actuation of the actuating arms 34. The guide clamp linkage 30 facilitates simultaneous actuation of the actuating arms 34. The clamping system within the guide clamps 28 is caused to grip the guide rail 24 with the guide shoes 38, thus causing the downward movement of the elevator car 27 to stop. Further downward movement of the elevator car 27 will cause the clamping system within the guide clamps 28 to more tightly grip the guide rail 24, thus immobilizing the elevator car 27 within the elevator hoistway. The guide shoes 38 maintain proper alignment of the guide clamps 28 and entire safety platform 10 during the use of the safety platform 10 during the repair or maintenance operation.

Once the elevator car 27 is immobilized, an elevator mechanic or building maintenance personnel can safely conduct the repair or maintenance. The rigging members 14 provide a point for connection of a hoist or other tools which will facilitate removal of a jack assembly or other hydraulic elevator components.

When the desired repair or maintenance operation has been completed, the safety platform 10 can be removed and the elevator car 27 returned to normal operation.

From the foregoing description, one ordinarily skilled in the art can easily ascertain the essential characteristics of this invention and, without departing from the spirit and scope thereof, can make various changes and modifications to the invention to adapt it to various usages and conditions.

1. A hydraulic elevator repair safety platform comprising:
an elongate central beam having a first end and a second end, said beam adapted to be connected to an elevator car; and
a guide clamp assembly connected to said beam and adapted to be received by an elevator guide rail system, said guide clamp assembly having at least one actuating arm adapted to be actuated by a downward movement of the elevator car, whereby actuation of said at least one actuating arm causes said guide clamp assembly to grip the guide rail system which facilitates immobilization of the elevator car.

2. The safety platform according to claim 1 including a first end portion connected to said first end of said beam and a second end portion connected to said second end of said beam, said first end portion and said second end portion adapted to be connected to the elevator car.

3. The safety platform according to claim 2, wherein said first end portion is adjustably connected to said first end of said beam and said second end portion is adjustably connected to said second end of said beam for selectively varying a distance between said first and second end portions.

4. The safety platform according to claim 1 wherein said guide clamp assembly includes a pair of guide clamps, one of said guide clamps being connected to said first end of said beam and another of said guide clamps being connected to said second end of said beam, the guide clamps adapted to be received by the elevator guide rail system, wherein said one guide clamp is actuated by said at least one actuating arm and said another guide clamp is actuated by another actuating arm to cause said guide clamps to grip the guide rail system.

5. The safety platform according to claim 4 wherein said guide clamp assembly includes a guide clamp linkage linking said at least one actuating arm to said another actuating arm to provide a simultaneous actuation said guide clamps.

6. The safety platform according to claim 5, wherein said guide clamp assembly includes a safety cable operatively connected to said guide clamp linkage to cause actuation of the actuating arm of each of the guide clamps.

7. The safety platform according to claim 4 wherein each of said guide clamps includes a pair of guide shoes for engagement with the guide rail system.

8. The safety platform according to claim 1 wherein said central beam includes a pair of spaced apart channel sections connected by a plurality of rigging members.

9. The safety platform according to claim 8 wherein said rigging members include U-bolts attached to said channel sections and to retaining rods extending between said channel sections.

10. A hydraulic elevator repair safety platform comprising:
an elongate central beam having a first end and a second end, said beam adapted to be connected to an elevator car; and
a pair of guide clamps, each of said guide clamps being connected to an associated one of said first and second ends of said beam and adapted to be received by an elevator guide rail system, each of said guide clamps having an actuating arm for actuation by a downward movement of the elevator car, whereby the actuation of the actuating arm of each of said guide clamps causes said guide clamps to grip the guide rail system which facilitates immobilization of the elevator car.

11. The safety platform according to claim 10 further comprising a first end portion disposed between said first end of said beam and one of said guide clamps, and a second end portion disposed between said second end of said beam and another of said guide clamps, said first end portion and said second end portion adapted to be connected to the elevator car.

12. The safety platform according to claim 11 wherein said first end portion is adjustably connected to said first end of said beam and said second end portion is adjustably connected to said second end of said beam for selectively varying a distance between said first and second end portions.

13. The safety platform according to claim 10 including a guide clamp linkage linking said actuating arms to provide a simultaneous actuation of said actuating arms.

14. The safety platform according to claim 13 including a safety cable connected to said guide clamp linkage for actuation of said actuating arms.

15. The safety platform according to claim 10 including a pair of guide shoes connected to each of said guide clamps to engage the elevator guide rail system.

16. A hydraulic elevator repair safety platform comprising:
an elongate central beam having a first end and a second end;
a first end portion disposed on the first end of said beam and adapted to be connected to an elevator car;
a second end portion disposed on the second end of said beam and adapted to be connected to the elevator car;
a pair of guide clamps adapted to be received by an elevator guide rail system, one of said guide clamps connected to said first end portion and another of said guide clamps connected to said second end portion, each of said guide clamps having an actuating arm, whereby the actuation of the actuating arm of each of said guide clamps causes said guide clamps to grip the guide rail system which facilitates immobilization of the elevator car;
a guide clamp linkage linking said actuating arms to provide a simultaneous actuation of said actuating arms; and
a cable operatively connected to said guide clamp linkage to cause actuation of said actuating arms in response to a downward movement of the elevator car.

17. The safety platform according to claim 16 wherein said first end portion is adjustably connected to said first end of said beam and said second end portion is adjustably connected to said second end of said beam.

18. The safety platform according to claim 16 including a pair of guide shoes connected to each of said guide clamps to engage the elevator guide rail system.
